(19) United States
(12) Patent Application Publication
(10) Pub. No.: US 2005/0207299 A1
(43) Pub. Date: Sep. 22, 2005

(54) Disk drive device and recording power setting method

(75) Inventors: Shigeo Yamaguchi, Kanagawa (JP); Susumu Seino, Kanagawa (JP); Masatoshi Nishino, Tokyo (JP); Junichi Horigome, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/072,519

(22) Filed: Mar. 7, 2005

(30) Foreign Application Priority Data
Mar. 19, 2004 (JP) 2004-081373

(51) Int. Cl. G11B 7/00

(52) U.S. Cl. 369/47.53

(57) ABSTRACT

To realize a disk drive device capable of setting optimum recording power by obtaining amplitude information of a reproduced signal even when low recording power is used. A disk drive device for recording and reproducing data on/from an optical disk is provided with: a Viterbi decoding means for performing Viterbi decoding on a reproduced signal reproduced from an optical disk to decode data and creating status data representing a status transition in the Viterbi decoding; and a quality index creation means for calculating a differential value between an amplitude reference value corresponding to the status transition recognized from the status data and a reproduced signal value created by digitizing the reproduced signal and creating a quality index value representing quality of the reproduced signal based on the differential value. The quality index creation means obtains a quality index value with the amplitude reference value fixed to a prescribed value, to create an amplitude evaluation value representing the amplitude of the reproduced signal.

### BACKGROUND OF THE INVENTION

1. Field of the Invention

This invention relates to a disk drive device and a recording power setting method and is suitably applied to a disk drive device for recording and reproduction on/from an optical disk.

2. Description of the Related Art

For optical disks on which data can be recorded, optimum recording power of laser light in recording is different due to characteristics of optical disk makers and characteristics of the optical disks. Therefore, disk drive devices which record data on optical disks should determine optimum recording power for the optical disks before recording data (for example, refer to Japanese Patent Laid-open No. 2003-168216).

The optimum recording power setting process is referred to as Optimum Power Control (OPC). In the OPC, a disk drive device records test data in a test region of an optical disk at certain recording power and then reads the test data. Then, this device obtains an amplitude evaluation value of a reproduced RF signal of this time based on a peak value and a bottom value of the reproduced RF signal.

The disk drive device repeats recording and reading of test data plural times in order to determine optimum recording power based on amplitude evaluation values.

### SUMMARY OF THE INVENTION

As described above, the OPC requires recording of test data in the test region of an optical disk plural times at different power. However, since optical disk durability has a limit, recording test data at higher recording power deteriorates quality of a recording layer and thus changes a reflectance and optimum recording power.

Therefore, a disk drive device performs the OPC at recording power lower than expected optimum recording power and determines optimum recording power based on an obtained amplitude evaluation value. However, using the low recording power results in a small amplitude of a reproduced RF signal and thus a Phase Locked Loop (PPL) cannot be locked for the reproduced RF signal and an amplitude evaluation value may not be obtained.

In view of foregoing, an object of this invention is to propose a disk drive device and a recording power setting method capable of setting optimum recording power by correctly obtaining amplitude information of reproduced signal even at low recording power, with a simple construction.

To solve the above problem, this invention provides a disk drive device for recording and reproducing data on/from an optical disk, with: a Viterbi decoding means for performing Viterbi decoding on a reproduced signal reproduced from an optical disk to decode data and creating status data representing a status transition in the Viterbi decoding; and a quality index creation means for calculating a differential value between an amplitude reference value and a reproduced signal value and creating a quality index value representing quality of the reproduced signal based on the differential value, the amplitude reference value corresponding to the status transition recognized from the status data, the reproduced signal value created by digitizing the reproduced signal. The quality index creation means creates an amplitude evaluation value representing the amplitude of the reproduced signal by obtaining the quality index value with the amplitude reference value fixed to a prescribed value.

Therefore, even when a PPL cannot be locked for the reproduced signal because the amplitude of the reproduced signal is small, the amplitude of the reproduced signal can be correctly recognized.

This invention further provides a recording power setting means for recording test data on the optical disk and setting optimum recording power for the optical disk based on the amplitude evaluation value of the reproduced signal obtained by reading the test data.

Therefore, even when the PPL cannot be locked for the reproduced signal because the amplitude of the reproduced signal is small, the amplitude of the reproduced signal is recognized and the optimum recording power for the optical disk can be set correctly.

Furthermore, in this invention, the test data is recorded on the optical disk at recording power much lower than the optimum recording power.

Therefore, the recording layer of the optical disk can be prevented from deteriorating due to writing of the test data.

According to this invention, even when a PPL cannot be locked for a reproduced signal because the amplitude of a reproduced signal is small, the amplitude of the reproduced signal is recognized and optimum recording power for an optical disk can be set correctly. As a result, low recording power can be used for test data and the recording layer of the optical disk can be prevented from deteriorating due to writing of the test data.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a block diagram showing an entire construction of a disk drive device;

FIG. 2 is a characteristic curve graph explaining amplitude reference values and reproduced signal values;

FIG. 3 is a flowchart showing an OPC procedure; and

FIG. 4 is a view explaining calculation of target power.

### DETAILED DESCRIPTION OF THE EMBODIMENT

Preferred embodiments of this invention will be described with reference to the accompanying drawings:

(1) Entire Construction of Disk Drive Device

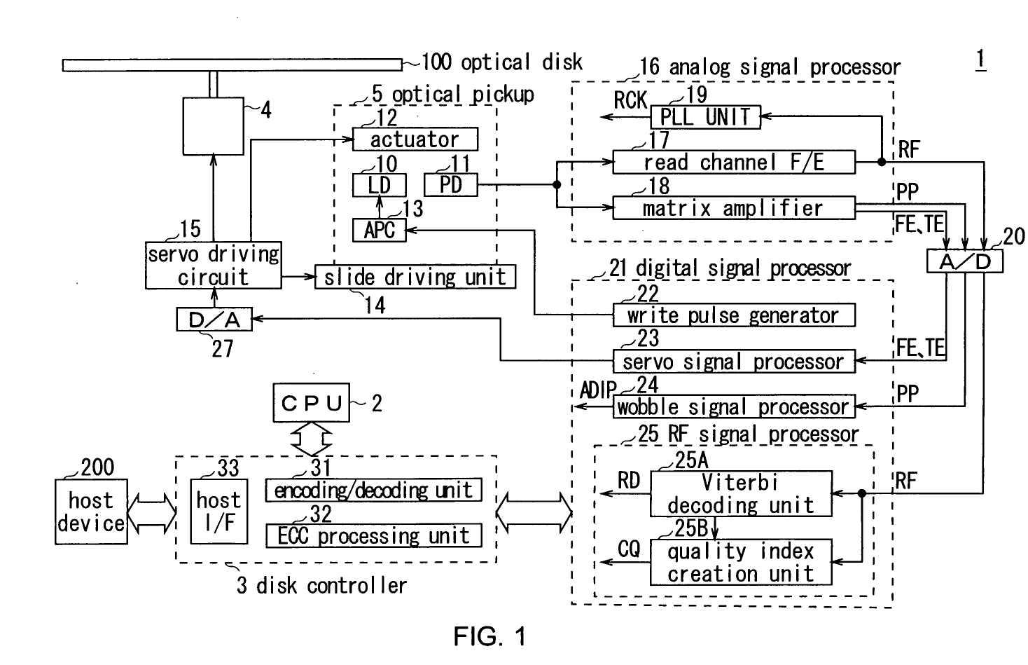

Referring to FIG. 1, reference numeral 1 shows a disk drive device according to this invention, and a CPU 2 entirely controls the disk drive device 1 via a disk controller 3. In addition, the disk drive device 1 records and reproduces data on/from an optical disk 100 in response to read/write commands received from a host device 200.

The optical disk 100 is placed on a turn table which is not shown. In accessing (recording and reproducing) data, the optical disk 100 is rotated by a spindle motor 4 serving as a driving means. Then, by an optical pickup 5 serving as an access means, data being recorded on the optical disk 100 and Address In Pre Groove (ADIP) information being recording in a wobbled groove are read out.

The optical pickup 5 has a laser diode 10 serving as a laser light source, a photo detector 11 for detecting reflected light, a biaxial actuator 12 for holding objective lens which is an output end of laser light, an Automatic Power Control (APC) circuit 13 for controlling output of the laser diode 10, and optical systems, which are not shown, for irradiating a disk recording surface with laser light via the objective lens and guiding its reflected light to the photo detector 11.

The biaxial actuator 12 holds the objective lens so as to be movable in a tracking direction and a focus direction. Further, a slide driving unit 14 moves the optical pickup 5 in a disk radiation direction under the control of the servo driving circuit 15.

The photo detector 11 has a plurality of photo diodes. Each photodiode performs photoelectric conversion on reflected light received from the optical disk 100, and creates a received light signal according to the light amount of the received light and gives it to an analog signal processor 16.

A read channel front end 17 of the analog signal processor 16 creates a reproduced RF signal from the received light signal and gives it to an analog/digital converter 20. A matrix amplifier 18, on the other hand, performs matrix calculation of the received light signal received from each photodiode to create a focus error signal FE and a tracking error signal TE for servo control and a push/pull signal PP which is wobbled groove information, and gives these to the analog/digital converter 20. A PLL unit 19 generates a read clock RCK from the reproduced RF signal.

The analog/digital converter 20 digitizes the reproduced RF signal, the focus error signal FE, the tracking error signal TE, and the push/pull signal PP and gives the resultants to a digital signal processor 21.

The digital signal processor 21 has a write pulse generator 22, a servo signal processor 23, a wobble signal processor 24 and an RF signal processor 25.

The wobble signal processor 24 decodes the push/pull signal PP, extracts ADIP information including an address and physical format information, and gives it to the CPU 2.

The servo signal processor 23 creates various kinds of servo drive signals including focus, tracking, slide and spindle, based on the focus error signal FE and the tracking error signal TE, and gives them to the servo driving circuit 15 via the digital/analog converter 27. The servo signal processor 23 gives a servo drive signal instructing to perform operation such as focus search, track jump and seeking, to the servo driving circuit 15 under the control of the CPU 2. The servo driving circuit 15 drives the biaxial actuator 12, the slide driving unit 14 and the spindle motor 4 according to the servo drive signal.

The RF signal processor 25 obtains reproduced data by performing Viterbi decoding on the reproduced RF signal read from the optical disk 100. That is, a Viterbi decoder 25A of the RF signal processor 25 sequentially selects the maximum likelihood status which is assumed based on a status transition pattern, based on the value (reproduced signal value) of a reproduced RF signal obtained at each timing specified by a read clock RCK. Then the Viterbi decoder 25A creates reproduced data RD based on the sequentially selected status data and gives the data to the disk controller 3.

At this time, a quality index creation unit 24B of the RF signal processor 24 obtains an amplitude reference value acxxx which is a logical value of an ideal reproduced RF signal without amplitude variation, based on the maximum likelihood status selected by the Viterbi decoder 24A. Further, the quality index creation unit 24B calculates an average value of differential values e[t] each between a reproduced signal value cxxx and the amplitude reference value acxxx of a reproduced RF signal at a sampling time.

This average value of the differential values e[t] corresponds to a difference between an ideal waveform and an actual waveform of a reproduced RF signal and represents quality of the reproduced RF signal. The quality index creation unit 24B outputs the average value as a quality index value CQ representing the quality of the reproduced RF signal.

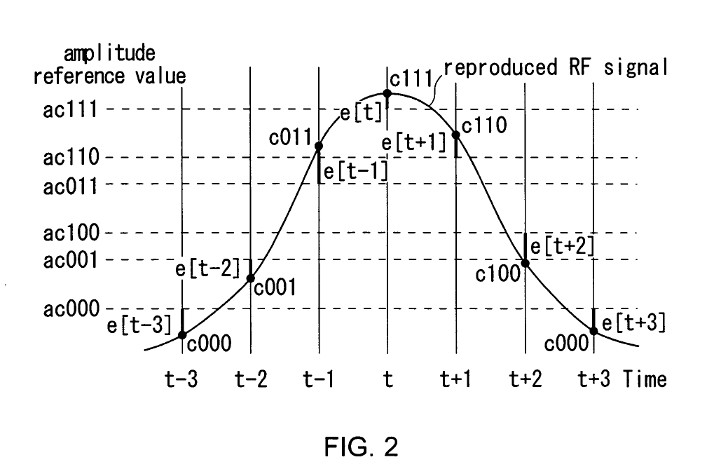

For example, as shown in FIG. 2, when the amplitude reference values at sampling times t−3, t−2, t−1, t, t+1, t+2, and t+3 are taken as ac000, ac001, ac011, ac111, ac110, ac100 and ac000 indicated by a dotted line and the reproduced signal values at these times are taken as c000, c001, c011, c111, c110, c100 and c000, the differential values at the sampling times are e[t−3]=ac000−c000, e[t−2]=ac001−c001, e[t−1]=ac011−c011, e[t]=ac111−c111, e[t+1]=ac110−c110, e[t+2]=ac100−c100, e[t+3]ac000−c000 indicated by a thick line. The quality index creation unit 24B calculates a quality index value CQ by using the following equation.
CQ=(e[t−3]+[t−2]+[t−1]+e[t]+e[t+1]+e[t+2]+2[t+3])/7. (1)

The disk controller 3 has an encoding/decoding unit 31, an Error Correcting Code (ECC) processing unit 32, and a host interface 33.

In reproduction, in the disk controller 3, the encoding/decoding unit 31 decodes the reproduced data received from the RF signal processor 26, and the ECC processing unit 32 performs error correction and transfers the resultant to the external host device 200 (for example, personal computer) via the host interface 33.

In addition, the encoding/decoding unit 31 of the disk controller 3 extracts sub code information, address information, management information and additional information from information obtained by the decoding process, and gives these information to the CPU 2.

In addition, the CPU 2 performs recording on the optical disk 100 in response to a write command received from the host device 200.

That is, in recording, in the disk controller 3, the ECC processing unit 32 adds an error correction code to recording data received from the host device 200, and the encoding/decoding unit 31 performs an Run Length Limited (RLL) encoding on the recording data to create an RLL(1, 7) code and gives this to the write pulse generator 22 of the digital signal processor 21.

The write pulse generator 22 creates laser modulation data by performing waveform reformation on the recording data and gives this to the APC circuit 13. The APC circuit 13 drives the laser diode 10 based on the laser modulation data to write data on the optical disk 100.

(2) OPC Process of Disk Drive Device

In addition to the above configuration, before first writing after the optical disk 100 is placed, the disk drive device 1 performs the OPC to set optimum recording power for the optical disk 100. At this time, the disk drive device 1 performs the OPC at recording power much lower than optimum recording power with a technique called κ-OPC, in order to prevent the recording layer of the optical disk 100 from deteriorating.

If low recording power is used, the amplitude of the reproduced RF signal is also small and the PLL cannot be locked for a reproduced RF signal, with the result that the amplitude of the reproduced signal may not be recognized. According to this invention, even when the amplitude of a reproduced RF signal is small and the PPL cannot be locked, the disk drive device 1 uses the above-described quality index creation unit 25B to recognize the amplitude and correctly perform the OPC at low recording power.

In performing the OPC, the quality index creation unit 25B of the disk drive device 1 calculates a quality index value CQ with an amplitude reference value acxxx fixed to “0”. In this case, the quality index value CQ corresponds to a sum of AD-converted values of a reproduced signal. When the reproduced RF signal is a periodical signal based on prescribed rules, the quality index value CQ is in proportional with the amplitude of the reproduced RF signal. Therefore, by writing test data in a prescribed pattern in the OPC, the amplitude of the reproduced RF signal can be evaluated by using the quality index value CQ.

A quality index value obtained with an amplitude reference value acxxx fixed to “0” is referred to as an amplitude evaluation value AMP. The amplitude evaluation value AMP is a value in proportional with the amplitude of a reproduced RF signal even while the PLL is not locked. Therefore, even when the OPC is performed at low recording power, the amplitude of the reproduced RF signal can be evaluated by using the amplitude evaluation value AMP.

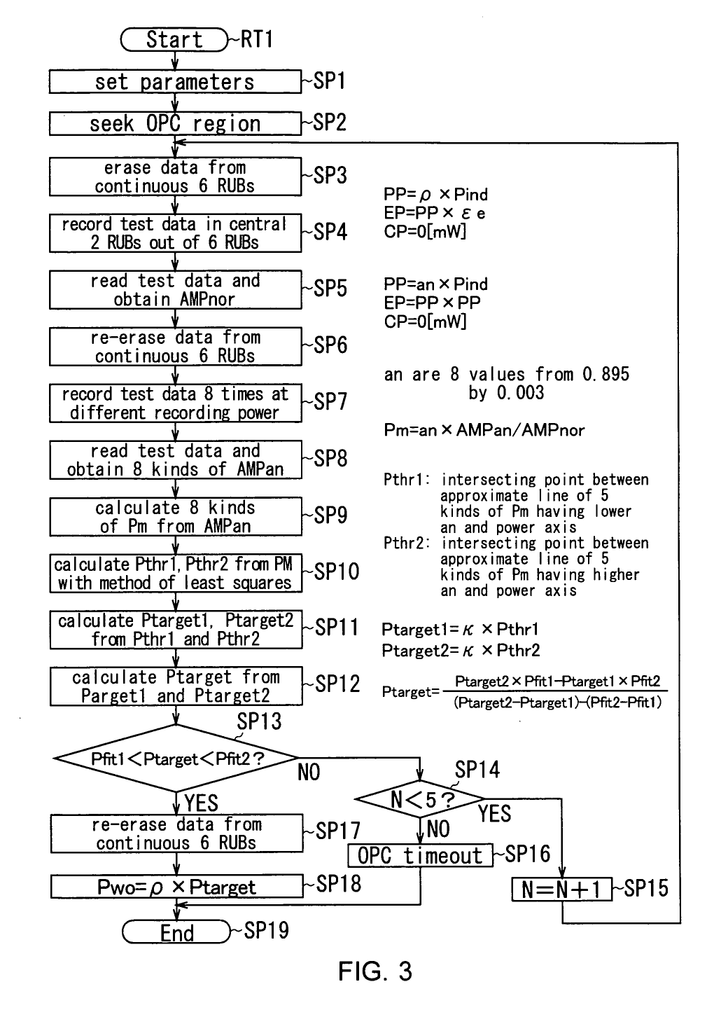

The OPC procedure using the above-described amplitude evaluation value AMP will be now described with reference to the flowchart of FIG. 3.

The CPU 2 serving as a recording power setting means enters start step of the OPC routine RT1 and moves on to step SP1 to set initial values of parameters (start power Pind, power coefficient ρ and peak/erase ratio εe) in the APC circuit 13, and then moves on to next step SP2.

At step SP2, the CPU 2 makes the optical pickup 5 seek the OPC region of the optical disk 100, and moves on to step SP3 to erase data from continuous 6 Recording Unit Blocks (RUBs) of the OPC region before writing test data, and then moves on to next step SP4.

At step SP4, the CPU 2 records the test data in the central 2 RUBs of the 6 RUBs at normalization recording power (Peak power PP=ρ×Pind, erase power EP=PP×εe, cool power CP=0 mw).

At the most inner circumference of the disk where the OPC region is provided, one track corresponds to 2 RUBs or a little less and the 6 RUBs from which the data has been erased corresponds to three tracks or a little more. Therefore, the tacks existing on both sides of the tack (2 RUBs) for recording the test data thereon has no data and thus, the correct OPC can be performed without influences of the neighboring tacks.

At next step SP5, the CPU 2 reads the test data from the OPC region, obtains a normalization amplitude evaluation value AMPnor of this time, and at next step SP6, re-erase data from the 6 RUBs subjected to the erasure of step SP3, and then moves on to next step SP7.

At step SP7, the CPU 2 records the test power in the central 2 RUBs out of the 6 RUBs at 8 different recording power. That is, a power coefficient an is set to 8 values from 0.895 by 0.03 steps, and the recording is performed with peak power PP=an×Pind, erase power EP=PP×εe, and cool power CP=0 mW.

At next step SP8, the CPU 2 reads the test data from the OPC region and obtains 8 amplitude evaluation values AMPan of this time and then, moves on to next step SP9. At step SP9, the CPU 2 calculates 8 normalization power values Pm based on the 8 amplitude evaluation values AMPan and the normalization amplitude evaluation value AMPnor with the following equation, and then moves on to next step SP10.
Pm=an×AMPan/AMPnor (2)

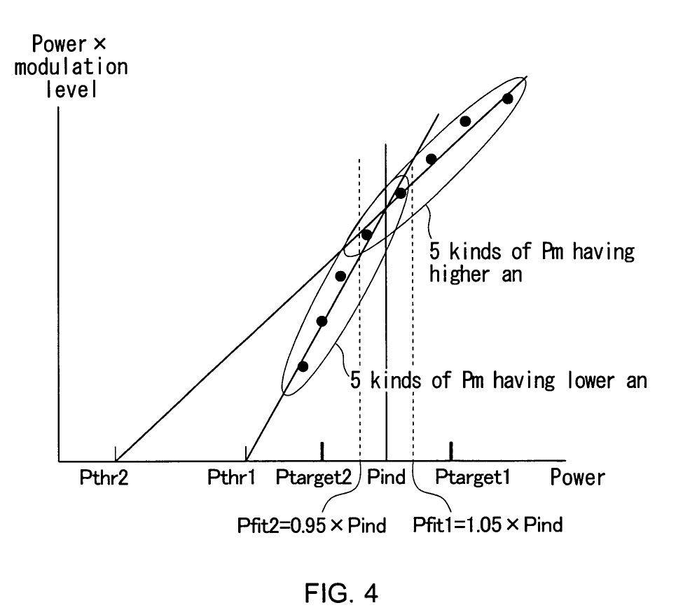

At step SP10, the CPU 2 calculates threshold power values Pthr1 and Pthr2 from the calculated 8 normalization power values Pm. As shown in FIG. 4, the threshold power value Pthr1 is a value of an intersecting point between an approximate line of 5 normalization power values Pm having lower power coefficients an and a power axis. The threshold power value Pthr2 is a value of an intersecting point between an approximate line of 5 normalization power values Pm having higher power coefficients an and the power axis.

At step SP11, the CPU 2 calculates a first target power value Ptarget1 and a second target power value Ptarget2 from the threshold power values Pthr1 and Pthr2 with the following equation, and then moves on to next step SP12.
Ptarget1=κ×Pthr1
Ptarget2=κ×Pthr2 (3)

At step SP12, the CPU 2 calculates a target power value Ptarget from the first target power value Ptarget1 and the second target power value Ptarget 2 with the following equation and then moves on to next step SP13.
Ptarget=(Ptarget2×Pfit1×Ptarget1×Pfit2)/((Ptarget2×Ptarget1)−(Pfit2−Pfit1))
Pfit1=1.045×Pind
Pfit2=0.955×Pind (4)

At step SP13, the CPU 2 determines whether the calculated target power value Ptarget is within a target range (Pfit1<Ptarget<Pfit2). If it is determined at step SP13 that the target power value Ptarget is out of the target range, this means that an appropriate target power value Ptarget cannot be obtained. In this case, the CPU 2 moves on to step SP14 and determines based on a counter value N (initial value “0”) of a retry counter whether the number of times of retry of the OPC is less than 5 times.

If it is determined at step SP14 that the number of times of retry is less than 5 times, the CPU 2 moves on to step SP5 and increases the counter value N of the retry counter by “1”, and then returns back to step SP3 to execute steps SP3 to SP13. If it is determined at step SP15 that the number of times of retry is 5 times or more, the CPU 2 moves on to step SP16 to confirm that the OPC process has been failed (OPC timeout), and moves on to step 19 to complete this OPC procedure.

If it is determined at step SP13 that the target power value Ptarget is within the target range, this means that an appropriate target value Ptarget can be obtained. In this case the CPU 2 moves on to step SP17 to erase data from the 6 RUBs being used, and then moves to next step SP18.

At step SP18, the CPU 2 sets the write power PWO to PWO=ρ×Ptarget, and then moves on to step SP19 to complete this OPC procedure.

(3) Operation and Effects

According to the above configuration, in normal data reproduction, the quality index creation unit 24B of the disk drive device 1 creates a quality index value CQ representing quality of a reproduced RF signal based on a difference between an amplitude reference value based on a most likelihood status detected by the Viterbi decoding unit 24A and the reproduced signal value of the reproduced RF signal.

In addition to this, in the OPC for the optical disk 100, the quality index creation unit 24B creates an amplitude evaluation value AMP representing the amplitude of the reproduced RF signal, instead of the quality index value CQ, with the amplitude reference value fixed to a prescribed value “0”. This amplitude evaluation value AMP indicates a value in proportional with the amplitude of the reproduced RF signal even if the PLL cannot be locked for the reproduced RF signal because low recording power is used to record test data and the small amplitude of the reproduced RF signal is obtained.

As a result, the disk drive device 1 can correctly recognize the amplitude of the reproduced RF signal based on the amplitude evaluation value AMP and perform the OPC at recording power much lower than optimum recording power.

In addition, the quality index creation unit 24B creates an amplitude evaluation value AMP with an amplitude reference value fixed to a prescribed value. Therefore, the amplitude of a reproduced RF signal can be correctly recognized with a simple construction, without an additional signal processing circuit, and the OPC can be performed at recording power much lower than optimum recording power.

According to the above configuration, the quality index creation unit 24B for creating a quality index value CQ is used to create an amplitude evaluation value AMP representing the amplitude of a reproduced RF signal. As a result, the OPC can be performed at low recording power with a simple construction, thereby being capable of preventing the recording layer of the optical disk 100 from deteriorating.

### (4) Other Embodiments

The above embodiment has described a case where this invention is applied to the disk drive device 1 for recording/reproduction on an optical disk. This invention, however, is not limited to this and can be applied to other disk drive devises which perform the Viterbi decoding on reproduced RF signals to obtain reproduced data.

Further, the above embodiment has described a case where test data is recorded 8 times at different recording power to perform the OPC. This invention, however, is not limited to this and test data can be recorded another number of times to perform the OPC.

This invention can be applied to a disk drive device for recording/reproduction on an optical disk.

While there has been described in connection with the preferred embodiments of the invention, it will be obvious to those skilled in the art that various changes and modifications may be aimed, therefore, to cover in the appended claims all such changes and modifications as fall within the true spirit and scope of the invention.

1. A disk drive device for recording and reproducing data on/from an optical disk, comprising:
viterbi decoding means for performing Viterbi decoding on a reproduced signal reproduced from the optical disk to decode the data, and creating status data representing a status transition in the Viterbi decoding; and
quality index creation means for calculating a differential value between an amplitude reference value and a reproduced signal value and creating a quality index value representing quality of the reproduced signal based on the differential value, the amplitude reference value corresponding to the status transition recognized from the status data, the reproduced signal value created by digitizing the reproduced signal, wherein
the quality index creation means obtains the quality index value with the amplitude reference value fixed to a prescribed value in order to create an amplitude evaluation value representing an amplitude of the reproduced signal.

2. The disk drive device according to claim 1, comprising
recording power setting means for recording test data on the optical disk and setting optimum recording power for the optical disk, based on the amplitude evaluation value of the reproduced signal obtained by reading the test data.

3. The disk drive device according to claim 2, wherein
the recording power setting means records the test data on the optical disk at recording power much lower than the optimum recording power.

4. A recording power setting method comprising:
a Viterbi decoding step of performing Viterbi decoding on a reproduced signal reproduced from an optical disk and creating status data representing a status transition in the Viterbi decoding; and
a quality index creation step of calculating a differential value between an amplitude reference value and a reproduced signal value and creating a quality index value representing quality of the reproduced signal based on the differential value, the amplitude reference value corresponding to the status transition recognized from the status data, the reproduced signal value created by digitizing the reproduced signal, wherein
the quality index value is obtained with the amplitude reference value fixed to a prescribed value in order to create an amplitude evaluation value representing an amplitude of the reproduced signal, and optimum recording power for the optical disk is set based on the amplitude evaluation value.

5. The recording power setting method according to claim 4, comprising
a test data recording step of recording test data on the optical disk, wherein
the optimum recording power is set based on the amplitude evaluation value of the reproduced signal obtained by reading the test data.

6. The recording power setting method according to claim 5, wherein
the test data is recorded on the optical disk at recording power much lower than the optimum recording power.
